(19) United States
(12) Patent Application Publication
(10) Pub. No.: US 2023/0266832 A1
(43) Pub. Date: Aug. 24, 2023

(54) TOUCH PEN SENSOR

(71) Applicant: Hewlett-Packard Development Company, L.P., Spring, TX (US)

(72) Inventors: Fred Charles Thomas, III, Fort Collins, CO (US); Cheng Huang, Palo Alto, CA (US); Bruce Eric Blaho, Fort Collins, CO (US); Mario E. Campos, Spring, TX (US); Christian M. Damir, Fort Collins, CO (US); J. Michael Stahl, Fort Collins, CO (US)

(73) Assignee: Hewlett-Packard Development Company, L.P., Spring, TX (US)

(21) Appl. No.: 18/006,860

(22) PCT Filed: Aug. 26, 2020
(86) PCT No.: PCT/US2020/047952

§ 371 Date: Jan. 25, 2023

(51) Int. Cl. G06F 3/0354; G06F 3/042; G06F 3/039

(52) U.S. Cl. CPC G06F 3/03542; G06F 3/0421; G06F 3/0395

(57) ABSTRACT

An example touch/pen (T/P) sensor device includes a T/P sensor to generate position information based on user interaction with a sensor surface of the T/P sensor, and a color sensor to sense a color hue of a writing tip of a pencil to be used to interact with the sensor surface of the T/P sensor to generate a digital image. The T/P sensor device also includes a processor to record metadata with the digital image to indicate the sensed color hue.

### BACKGROUND

Some computing devices employ touch-based input methods that allow a user to physically touch, for example, an associated display or an indirect touch device without a display. The touch may be registered as an input at the particular touch location, thereby enabling a user to interact physically with objects shown on the display of the computing device. Digital pens may also be used in conjunction with computing devices and provide a natural and intuitive way for users to input information into applications running on the computing devices.

### BRIEF DESCRIPTION OF THE DRAWINGS

FIG. 1 is a diagram illustrating a top view of a touch/pen (T/P) sensor device, according to an example.

FIG. 2 is a block diagram illustrating elements of a T/P sensor device, according to an example.

FIG. 3 is a layer diagram illustrating layers of a T/P sensor device, according to an example.

FIG. 4 is a diagram illustrating layers of the backlight stack of the T/P sensor device shown in FIG. 1, according to an example.

FIG. 5 is a block diagram illustrating a T/P sensor device, according to another example.

FIG. 6 is a block diagram illustrating an indirect T/P sensor device, according to an example.

FIG. 7 is a flow diagram illustrating a method of operating a T/P sensor device, according to an example.

### DETAILED DESCRIPTION

In the following detailed description, reference is made to the accompanying drawings which form a part hereof, and in which is shown by way of illustration specific examples in which the disclosure may be practiced. It is to be understood that other examples may be utilized and structural or logical changes may be made without departing from the scope of the present disclosure. The following detailed description, therefore, is not to be taken in a limiting sense, and the scope of the present disclosure is defined by the appended claims. It is to be understood that features of the various examples described herein may be combined, in part or whole, with each other, unless specifically noted otherwise.

Some examples are directed to an indirect inking and pointing device with electro-optical features. The device is a referred to as an “indirect” device because it is a standalone touch/pen (T/P) sensor device that is not integrated with a display. The term “touch/pen” or “T/P” sensor as used herein includes touch-based interfaces, pen-based interfaces, and interfaces that are both touch-based and pen-based. Touch/pen inputs from the device may be relayed to a universal serial bus (USB) attached client computer. The T/P sensor device may be used with an active digital pen or a passive digital pen, and may also be used to track writing by pencils (e.g., lead or graphite based color pencils) or ink pens on paper positioned on the device. The electro-optical features according to some examples include: (1) a lightbox beneath the digital scribing area to background illuminate an item to be traced; (2) a red-green-blue (RGB) color sensor for determining the color hue of a writing tip of a color pencil to be used on the device to create a digital image, wherein metadata related to the color hue is recorded with the digital image; (3) RGB light emitting diodes (LEDs) and a light shuttering mechanism for emitting light patterns from the device (e.g., lighting a border of a mouse region of the device when the device is used as a mouse pad in a mouse mode).

The T/P sensor surface may comprise a projected capacitive (p-cap) sensor. Some example material types for this sensor include, but are not limited to, indium-tin-oxide (ITO), silver nanowire, metal mesh, carbon nano-tube, and poly(3,4-ethylenedioxythiophene) (PEDOT) film. These sensor films are clear, electrically-conductive layers that may be fabricated into a row and column p-cap sensor array, and that may be formed on a clear plastic layer (e.g., polyethylene terephthalate (PET)) or a clear glass substrate.

In some examples, the T/P sensor device includes an analog-to-digital (A-to-D) sampling controller coupled to the T/P sensor surface. In some examples, the A-to-D sampling controller may be a sigma-delta A-to-D sampling controller that has drive and sense electrodes operated in parallel and that filters out noise from the measured voltage-based capacitive signals. An example sigma-delta A-to-D sampling controller is able to filter out p-cap noise, while operating at high frequency touch/pen image capture rates. In some examples, the sigma-delta controller is able to image a T/P sensor surface at between 100 and 600 frames per second.

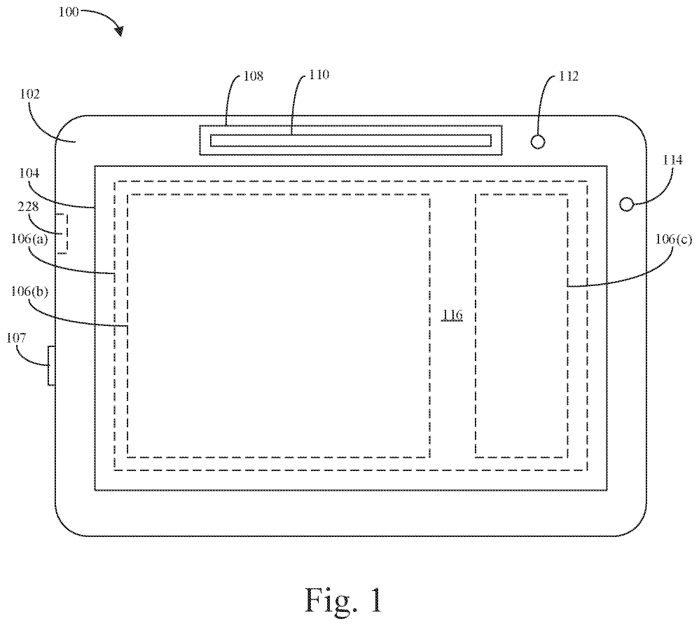

FIG. 1 is a diagram illustrating a top view of a touch/pen (T/P) sensor device 100 according to an example. In some examples, T/P sensor device 100 is an indirect T/P sensor device that is not integrated with a display. T/P sensor device 100 includes a plastic outer frame 102, USB hub port 228, power/reset switch 107, pen docking station 108, digital pen 110, pen charge status (green/yellow/red) indicator 112, RGB color sensor 114, and T/P sensor surface 116.

T/P sensor surface 116 is defined by an outer border 104 that corresponds to an inner border of the outer frame 102. The outer frame 102 surrounds a perimeter of the T/P sensor surface 116. Pen docking station 108 is positioned at a top portion of the outer frame 102, and is sized to receive and securely hold the digital pen 110. In some examples, the digital pen 110 includes a general-purpose input/output (GPIO) port and a Micro SD card port. The digital pen 110 is wirelessly chargeable by the T/P sensor device 100, and an indication of the current charging status is provided by indicator 112. In some examples, the digital pen 110 wirelessly communicates with electronics of the T/P sensor device 100 via Bluetooth communications.

The RGB color sensor 114 is positioned on a right side of the outer frame 102 and senses a color hue of a writing tip of a color pencil to be used with the T/P sensor device 100. Color pencils may come in a variety of different colors for producing writings in those corresponding colors. For example, a red color pencil produces writings in a red color. Prior to using a color pencil with device 100, a user may position the writing tip of the color pencil on the RGB color sensor 114 to sense the color hue of the writing tip (e.g., lead or graphite) of the color pencil. As this color pencil is used to, for example, trace on a piece of paper positioned on device 100, device 100 tracks the strokes made by the color pencil and stores this information as a digital image. Device 100 also stores metadata, including the sensed color hue, along with the digital image. Device 100 may output the digital image and associated metadata to a host device via USB communications. The host device may then display the digital image and use the sensed color hue information contained in the metadata to display writing strokes made by the color pencil in a color corresponding to the sensed color hue.

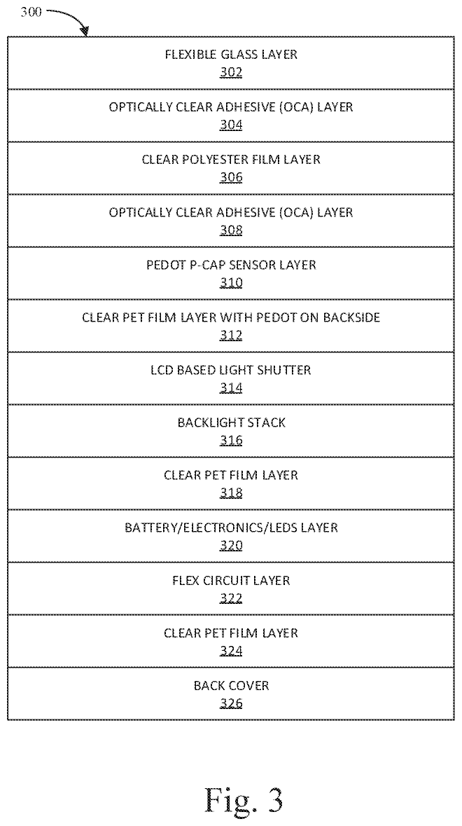

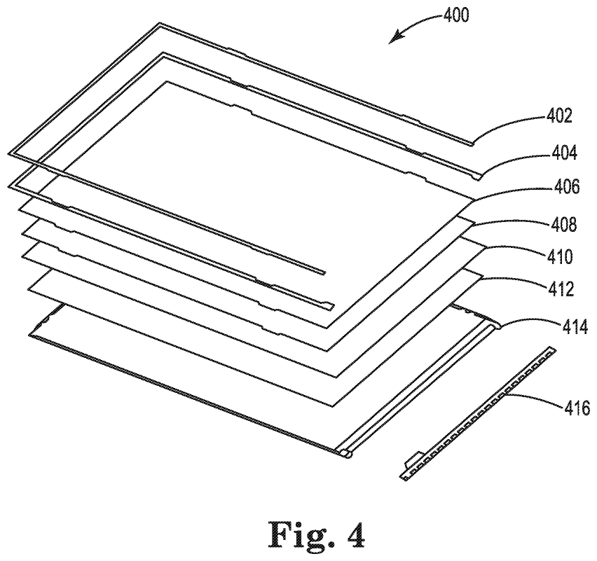

T/P sensor device 100 may include a backlight stack, such as backlight stack 400 (FIG. 4), to project light from a back side of the T/P sensor device 100 and through the T/P sensor surface 116. The backlight stack may operate in a backlight mode (also referred to herein as a lightbox mode) to emit white light and may operate in an RGB mode to emit RGB-based light colors. The backlight stack may provide modulated sequences of RGB colors. T/P sensor device 100 may also include a light shuttering mechanism, such as light shuttering mechanism 314 (FIG. 3), to selectively shutter the light emitted by the backlight stack to identify with the emitted light at least one border 106(a), 106(b), or 106(c) defining at least one region on the T/P sensor surface 116. The regions defined by the borders 106(a), 106(b), and 106(c) may also be illuminated, and different colors may be used for different borders and different regions. The amount of light that is blocked by the light shuttering mechanism may also be individually controlled for each of the different borders and/or regions defined by the borders. In some examples, the illuminated borders 106(a), 106(b), and 106(c) have a border line thickness of about 2 mm. In other examples, other border line thicknesses may be used. The light shuttering mechanism allows the device 100 to produce various aesthetic RGB lighting features.

In some examples, the T/P sensor device 100 senses when a mouse device is used on the sensor surface 116 and switches to a mouse pad mode in response to the sensed mouse device. The mouse device may be detected, for example, by detecting the mouse shape or fiducials on the mouse device. In the mouse pad mode, the light shuttering mechanism selectively shutters RGB or white light emitted by the backlight stack to identify with the emitted light a mouse pad border 106(a) defining a mouse pad region on the sensor surface 116 as the region within the mouse pad border 106(a). For example, the shuttering mechanism may block light from passing through a central portion of the sensor surface 116, such that an illuminated rectangular border 106(a) appears around the perimeter of the sensor surface 116.

In some examples, the light shuttering mechanism selectively shutters RGB or white light emitted by the backlight stack to identify with the emitted light a border 106(b) defining a pen region for pen interactions on the sensor surface 116, and another border 106(c) defining a touch region for touch interactions on the sensor surface 116.

In some examples, the light shuttering mechanism selectively shutters RGB or white light emitted by the backlight stack to identify with the emitted light a border 106(b) defining a first region associated with a first external display device, and another border 106(c) defining a second region associated with a second external display device. For example, when a user interacts with the first region defined by border 106(b), such as by drawing in the first region, the information displayed by the first external display device may be updated to reflect the user interaction, while the information displayed by the second external display device remains unchanged. When a user interacts with the second region defined by border 106(c), such as by drawing in the second region, the information displayed by the second external display device may be updated to reflect the user interaction, while the information displayed by the first external display device remains unchanged. In other examples, other borders for other types of regions may be identified with light from the backlight stack.

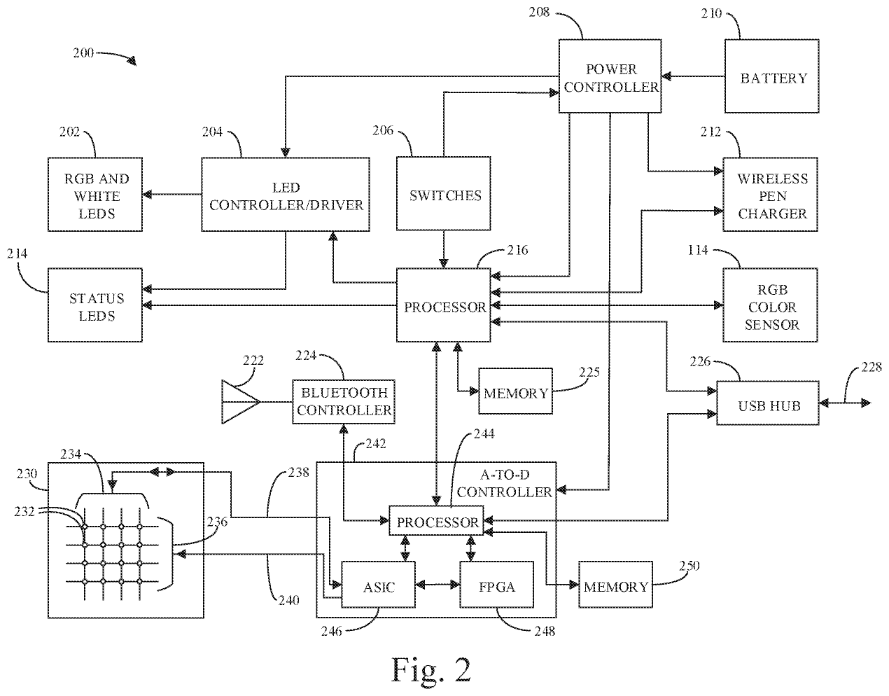

FIG. 2 is a block diagram illustrating elements of a T/P sensor device 200, according to an example. T/P sensor device 200 is an example of T/P sensor device 100 (FIG. 1). T/P sensor device 200 includes RGB and white LEDs 202, LED controller/driver 204, switches 206, power controller 208, battery 210, wireless pen charger 212, status LEDs 214, processor 216, RGB color sensor 114, Bluetooth antenna 222, Bluetooth controller 224, memory 225, USB hub 226, T/P sensor 230, analog-to-digital (A-to-D) controller 242, and memory 250. A-to-D controller 242 includes processor 244, application specific integrated circuit (ASIC) 246, and field programmable gate array 248.

Processors 216 and 244 may each include a central processing unit (CPU) or another suitable processor. In an example, memory of device 200 (e.g., memory 225, memory 250, or other memory) stores machine readable instructions executed by processors 216 and 244 for operating device 200. The memory includes any suitable combination of volatile and/or non-volatile memory, such as combinations of Random-Access Memory (RAM), Read-Only Memory (ROM), flash memory, and/or other suitable memory. These are examples of non-transitory computer readable media (e.g., non-transitory computer-readable storage media storing computer-executable instructions that when executed by at least one processor cause the at least one processor to perform a method). The memories are non-transitory in the sense that they do not encompass a transitory signal but instead are made up of at least one memory component to store machine executable instructions for performing techniques described herein.

Battery 210 provides power to power controller 208, which distributes power to LED controller/driver 204, wireless pen charger 212, processor 216, and A-to-D controller 242. In an example, battery 210 is a 3.7 VDC battery. Switches 206, which include power/reset switch 107 (FIG. 1), and may also include other switches, such as a mode of operation switch, are communicatively coupled to power controller 208 and processor 216 for controlling operation of T/P sensor device 200.

Processor 216 is communicatively coupled to LED controller/driver 204 to control the driving of the LEDs 202 and 214 by the controller/driver 204. In some examples, LEDs 202 include white LEDs for providing lightbox functionality (backlight mode), as well as RGB LEDs (RGB mode) for providing additional functionality described herein. The lightbox functionality involves projecting light through the T/P sensor surface 116 (FIG. 1) to background illuminate an object (e.g., a sheet of paper) placed on the T/P sensor surface 116 to, for example, facilitate tracing of an item on the paper. In some examples, LEDs 214 include LEDs to provide status information, such as on/off state, low battery state, mode of operation, and pen charge status.

Processor 216 is communicatively coupled to wireless pen charger 212 to control the charging of the digital pen 110 (FIG. 1). Processor 216 is communicatively coupled to USB hub 226 to communicate with a host computing device attached to the USB hub port 228.

Processor 216 is communicatively coupled to RGB color sensor 114 to receive sensed color information from the sensor 114, indicating the color hue of a writing tip of a color pencil. As the color pencil is used to, for example, trace on piece of paper positioned on the T/P sensor 230, the T/P sensor 230 and A-to-D controller 242 track the strokes made by the color pencil and store this information as a digital image. Processor 216 stores metadata, including the sensed color hue. A-to-D controller 242 stores the digital image. Processor 244 and processor 216 may output the digital image and associated metadata to a host device via USB hub 226. The host device may then display the digital image and use the sensed color hue information contained in the metadata to display writing strokes made by the color pencil in a color corresponding to the sensed color hue.

T/P sensor 230 includes a plurality of sense electrodes 234, a plurality of drive electrodes 236, and a plurality of capacitive nodes 232. The sense electrodes 234 are conductive traces represented by a plurality of equally spaced vertical lines, and the drive electrodes 236 are conductive traces represented by a plurality of equally spaced horizontal lines. The intersections of the sense electrodes 234 and the drive electrodes 236 correspond to the locations of the capacitive nodes 232. In some examples, the T/P sensor 230 may include at least one p-cap indium-tin-oxide (ITO), silver nanowire, metal mesh, carbon nano-tube, or PEDOT film.

The sense electrodes 234 and drive electrodes 236 may be used to sense the position of a pen or pencil writing tip, or another object. In an example, user interaction with the T/P sensor 230, such as positioning a pen or pencil writing tip near one of the capacitive nodes 232, causes a change in capacitance at that node 232. This change in capacitance at that node 232 is sensed and indicates a current position of the writing tip on the T/P sensor 230. In an example, electrodes 234 and 236 continually generate analog position information for identifying a current position of an object being used by a user to interact with the T/P sensor 230. The position of the writing tip as it moves across the T/P sensor 230 may be continually tracked to sense pen or pencil strokes. In some examples, the sense electrodes 234 and drive electrodes 236 are about 4-5 mm wide, with a pitch of about 100 mm. Sensing of position of a digital pen with a fine tip (e.g., about 0.5 mm to 2 mm diameter or less) may involve triangulation of tip location using multiple signals from the trace intersections closest to the pen tip point touch down location, and other trace crossings surrounding the touch down location.

The sense electrodes 234 are coupled to ASIC 246 via communication link 238. In an example, communication link 238 includes a separate conductive line for each of the sense electrodes 234. The drive electrodes 236 are coupled to ASIC 246 via communication link 240. In an example, communication link 240 includes a separate conductive line for each of the drive electrodes 236.

In some examples, ASIC 246 is a hybrid analog/digital ASIC, and FPGA 248 is a digital FPGA. ASIC 246 may include a closed-loop touch line current driver, a sigma-delta converter with 1-bit digital to analog converter (DAC), and a sensor receiver. FPGA 248 may include a digital signal processor (DSP). It is noted that the controller 242 shown in FIG. 2 is an example of a sigma-delta p-cap T/P imaging controller, and in other examples, controller 242 may be configured differently than shown in FIG. 2.

In an example, ASIC 246 provides an analog front-end (AFE) with a data rate of about 300 to 600 frames per second (i.e., 300 to 600 Hz), and ASIC 246 drives and reads up to 64 channels in parallel. For example, if the controller 242 is operated at 500 Hz, the T/P sensor 230 may be completely sampled at 500 Hz. ASIC 246 outputs analog drive signals via communication link 240. A closed-loop touch line current driver in ASIC 246 receives analog sense signals via communication link 238 and provides the analog sense signals to a sigma-delta converter of the ASIC 246. Additionally, a closed-loop touch line current driver in ASIC 246 may be coupled to a sensor receiver to facilitate the generation of drive signals. In some examples, the driving and sensing of each electrode occurs individually and in parallel. The sigma-delta converter of ASIC 246 performs a delta-sigma modulation process and converts the analog sense signals into digital sense signals, which are output to a DSP of FPGA 248.

In some examples, the sigma-delta converter of ASIC 246 encodes analog signals using high-frequency delta-sigma modulation, and then applies a digital filter to form a higher-resolution but lower sample-frequency digital output. Delta-sigma modulation involves delta modulation in which the change in the signal (i.e., its delta) is encoded, resulting in a stream of pulses. Accuracy of the modulation may be improved by passing the digital output through a 1-bit DAC and adding (sigma) the resulting analog signal to the input signal (the signal before delta modulation), thereby reducing the error introduced by the delta modulation.

The DSP of FPGA 248 performs filtering of the digital sense signals received from the sigma-delta converter of ASIC 246, and touch/pen image extraction. In some examples, FPGA 248 provides full touch/pen images to processor 244, which may save the full touch/pen images to memory 250. In some examples, FPGA 248 also performs touch processing (e.g., finger/pen coordinates, palm rejection, gesture interpretation, etc.). Processor 244 outputs the full touch/pen images to a host device via USB hub 226, or conversely processor 244 may provide touch/pen coordinate information universal serial bus (USB) human interface device (HID) packets to the host device via USB hub 226. In some examples, USB hub 226 is a USB2+ hub. In some cases, processor 244 may provide both touch image as well as USB HID packets to the host device.

Processor 244 is communicatively coupled to Bluetooth controller 224 to wirelessly communicate with digital pen 110 (FIG. 1) via antenna 222. Processor 244 is also communicatively coupled to processor 216.

FIG. 3 is a layer diagram illustrating layers of a T/P sensor device 300, according to an example. T/P sensor device 300 is an example of T/P sensor device 100 (FIG. 1). T/P sensor device 300 includes flexible glass layer 302, optically clear adhesive (OCA) layer 304, clear polyester film layer 306, OCA layer 308, PEDOT p-cap sensor layer 310, clear PET film layer with PEDOT film on backside (for ground plane) 312, liquid crystal display (LCD) based light shutter 314, backlight stack 316, clear PET film layer 318, battery/electronics/LEDs layer 320, flexible (flex) circuit layer 322, clear PET film layer 324, and back cover 326. In an example, layer 302 has a thickness of 100 um, layer 304 has a thickness of 50 um, layer 306 has a thickness of 75 um, layer 308 has a thickness of 50 um, layer 310 has a thickness of 125 um, layer 312 has a thickness of 125 um, light shutter 314 has a thickness of 500 um, backlight stack 316 has a thickness of 800 um; layer 318 has a thickness of 50 um, layer 320 has a thickness of 2000 um, layer 322 has a thickness of 320 um, layer 324 has a thickness of 50 um, and back cover 326 has a thickness of 350 um.

Layers 310 and 312 represent a p-cap sensor stack. In some examples, the drive conductive traces (i.e., drive electrodes) for the sensor stack are in layer 310, and the sense conductive traces (i.e., sense electrodes) for the sensor stack are in the PEDOT film of layer 312. The p-cap sensor (e.g., PEDOT) layers are clear, electrically-conductive layers that are fabricated into row and column p-cap sensor arrays, which are formed on a clear plastic or glass layer (e.g., polyethylene terephthalate (PET) or soda-lime glass). The fabrication process may include increasing the surface resistance of portions/areas of the PEDOT film by orders of magnitude via wet-printing of the PEDOT film with a chemical agent. In contrast, fabrication processes for other materials typically involve adding trace material to the layer or etching material off the layer.

In some examples, light shutter 314 is an opaque cholesteric liquid crystal display (ChLCD), or chiral nematic, light shuttering mechanism. In some examples, the layers above the light shutter 314 are translucent, and allow light from the backlight stack 316 to pass through these layers. Clear PET film layer 318 provides electrical isolation between layers 316 and 320. In some examples, flex circuit layer 322 is a two-layer flex circuit. Clear PET film layer 324 provides electrical isolation.

FIG. 4 is a diagram illustrating layers of a backlight stack 400 of a T/P sensor device, according to an example. Backlight stack 400 may be included in T/P sensor device 100 (FIG. 1) and is an example implementation of the backlight stack 316 (FIG. 3). Backlight stack 400 includes tape layer 402, frame 404, brightness enhancement film (BEF) 406, diffuser 408, light guide plate (LGP) 410, reflector 412, back bezel 414, and LED array 416. In an example, tape layer 402 has a thickness of 0.1 mm, BEF 406 has a thickness of 0.09 mm; diffuser 408 has a thickness of 0.1 mm, LGP 410 has a thickness of 0.6 mm; reflector 412 has a thickness of 0.1 mm, and back bezel 414 has a thickness of 0.4 mm.

LED array 416 is positioned at a bottom end of the backlight stack 400, and includes white LEDs and RGB LEDs that generate light that is directed upward and through the stack 400. In some examples, the LED array 416 includes 14 white LEDs to produce a backlight with about 1000 nits brightness, and 14 RGB LEDs to produce RGB light with about 100 nits brightness. One nit is equal to one candela per square meter (cd/m²). Brightness may be controlled via an attached host computer, or via physical control on the device 100. Reflector 412 directs the light from the LED array 416 upward and through the stack 400. The light is reflected internally within the LGP 410 and is distributed evenly over the upper surface of the LGP 410. In some examples, diffuser 408 is a holographic diffuser that further disperses the light to provide uniform illumination across the sensor surface 116. BEF 406 increases the brightness of the emitted light. Light shutter 314 (FIG. 3) is positioned over the backlight stack 400 to selectively block at least a portion of the light being emitted by the backlight stack 400.

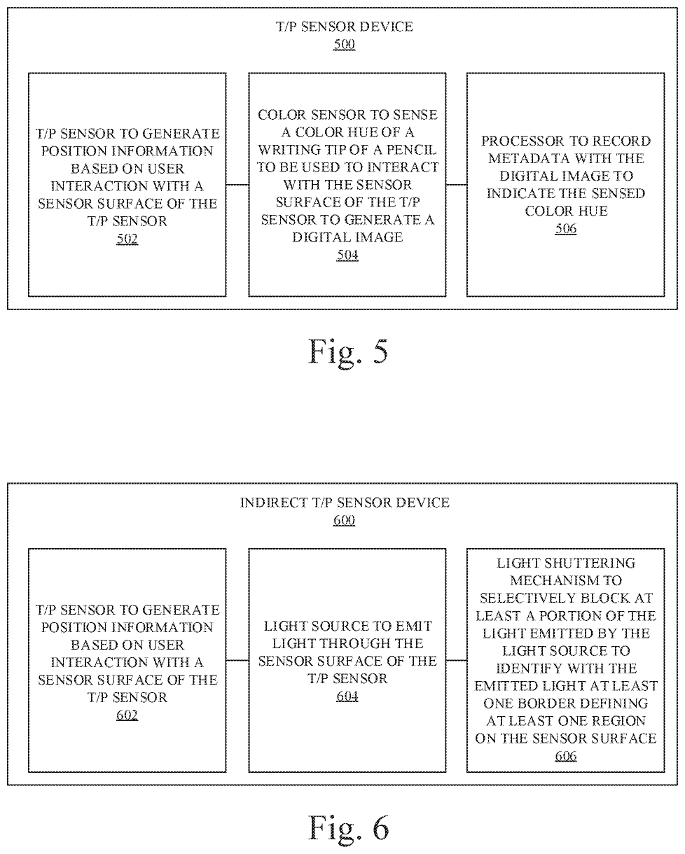

An example is directed to a T/P sensor device. FIG. 5 is a block diagram illustrating a T/P sensor device 500, according to another example. T/P sensor device 500 includes a T/P sensor 502 to generate position information based on user interaction with a sensor surface of the T/P sensor, a color sensor 504 to sense a color hue of a writing tip of a pencil to be used to interact with the sensor surface of the T/P sensor to generate a digital image, and a processor 506 to record metadata with the digital image to indicate the sensed color hue.

The T/P sensor device 500 may be an indirect T/P sensor device without an integrated display. The color sensor 504 may be built into a frame coupled to and surrounding the sensor surface. The color sensor 504 may be an RGB color sensor. The T/P sensor device 500 may output the digital image and the metadata to an external display device to display the digital image using the metadata for color information. The sensor surface may comprise a projected capacitive array type sensor that generates analog position information, and the T/P sensor 502 may include a sigma-delta A-to-D sampling controller to control the sensor surface and generate digital position information based on the analog position information. The sensor surface may comprise an ITO, silver nanowire, metal mesh, carbon nano-tube, or PEDOT film.

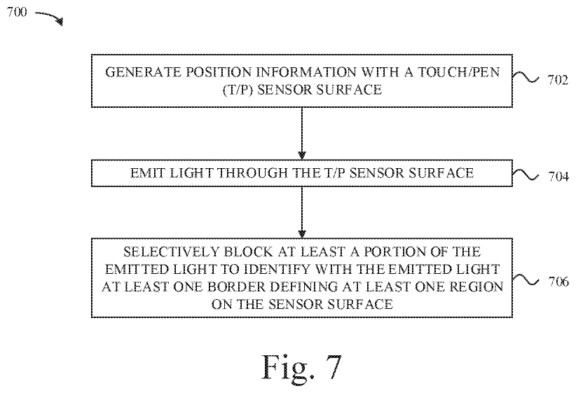

Another example is direct to an indirect T/P sensor device. FIG. 6 is a block diagram illustrating an indirect T/P sensor device 600, according to an example. Indirect T/P sensor device 600 includes a T/P sensor 602 to generate position information based on user interaction with a sensor surface of the T/P sensor, a light source 604 to emit light through the sensor surface of the T/P sensor, and a light shuttering mechanism 606 to selectively block at least a portion of the light emitted by the light source to identify with the emitted light at least one border defining at least one region on the sensor surface.

The light source 604 may comprise at least one of a white light source and an RGB light source. The light shuttering mechanism 606 may comprise a ChLCD light shuttering mechanism. The indirect T/P sensor device 600 may sense when a mouse device is used on the sensor surface and switch to a mouse pad mode in response to the sensed mouse device, and the light shuttering mechanism 606 may selectively block at least a portion of the light emitted by the light source 604 to identify with the emitted light a mouse pad border defining a mouse pad region on the sensor surface. The light shuttering mechanism 606 may selectively block at least a portion of the light emitted by the light source 604 to identify with the emitted light a first border defining a pen region for pen interactions on the sensor surface, and a second border defining a touch region for touch interactions on the sensor surface. The light shuttering mechanism 606 may selectively block at least a portion of the light emitted by the light source 604 to identify with the emitted light a plurality of borders defining a corresponding plurality of regions on the sensor surface, and wherein the light shuttering mechanism 606 may independently control the amount of light emitted for each of the regions.

Another example is directed to a method of operating a T/P sensor device. FIG. 7 is a flow diagram illustrating a method 700 of operating a T/P sensor device, according to an example. At 702, the method 700 includes generating position information with a T/P sensor surface. At 704, the method 700 includes emitting light through the T/P sensor surface. At 706, the method 700 includes selectively blocking at least a portion of the emitted light to identify with the emitted light at least one border defining at least one region on the sensor surface.

The at least one region in method 700 may comprise at least one of a mouse pad region for mouse device interactions, a pen region for pen interactions, and a touch region for touch interactions.

Although specific examples have been illustrated and described herein, a variety of alternate and/or equivalent implementations may be substituted for the specific examples shown and described without departing from the scope of the present disclosure. This application is intended to cover any adaptations or variations of the specific examples discussed herein. Therefore, it is intended that this disclosure be limited only by the claims and the equivalents thereof.

1. A touch/pen (T/P) sensor device, comprising:
a T/P sensor to generate position information based on user interaction with a sensor surface of the T/P sensor;
a color sensor to sense a color hue of a writing tip of a pencil to be used to interact with the sensor surface of the T/P sensor to generate a digital image; and
a processor to record metadata with the digital image to indicate the sensed color hue.

2. The T/P sensor device of claim 1, wherein the T/P sensor device is an indirect T/P sensor device without an integrated display.

3. The T/P sensor device of claim 1, wherein the color sensor is built into a frame coupled to and surrounding the sensor surface.

4. The T/P sensor device of claim 1, wherein the color sensor is a red, green, blue (RGB) color sensor.

5. The T/P sensor device of claim 1, wherein the T/P sensor device is to output the digital image and the metadata to an external display device to display the digital image using the metadata for color information.

6. The T/P sensor device of claim 1, wherein the sensor surface comprises a projected capacitive array type sensor that generates analog position information, and wherein the T/P sensor includes a sigma-delta analog-to-digital (A-to-D) sampling controller to control the sensor surface and generate digital position information based on the analog position information.

7. The T/P sensor device of claim 1, wherein the sensor surface comprises an indium-tin-oxide (ITO), silver nanowire, metal mesh, carbon nano-tube, or poly(3,4-ethylenedioxythiophene) (PEDOT) film.

8. An indirect touch/pen (T/P) sensor device, comprising:
a T/P sensor to generate position information based on user interaction with a sensor surface of the T/P sensor;
a light source to emit light through the sensor surface of the T/P sensor; and
a light shuttering mechanism to selectively block at least a portion of the light emitted by the light source to identify with the emitted light at least one border defining at least one region on the sensor surface.

9. The indirect T/P sensor device of claim 8, wherein the light source comprises at least one of a white light source and a red, green, blue (RGB) light source.

10. The indirect T/P sensor device of claim 8, wherein the light shuttering mechanism comprises a cholesteric liquid crystal display (ChLCD) light shuttering mechanism.

11. The indirect T/P sensor device of claim 8, wherein the indirect T/P sensor device is to sense when a mouse device is used on the sensor surface and switch to a mouse pad mode in response to the sensed mouse device, and wherein the light shuttering mechanism is to selectively block at least a portion of the light emitted by the light source to identify with the emitted light a mouse pad border defining a mouse pad region on the sensor surface.

12. The indirect T/P sensor device of claim 8, wherein the light shuttering mechanism is to selectively block at least a portion of the light emitted by the light source to identify with the emitted light a first border defining a pen region for pen interactions on the sensor surface, and a second border defining a touch region for touch interactions on the sensor surface.

13. The indirect T/P sensor device of claim 8, wherein the light shuttering mechanism is to selectively block at least a portion of the light emitted by the light source to identify with the emitted light a plurality of borders defining a corresponding plurality of regions on the sensor surface, and wherein the light shuttering mechanism is to independently control the amount of light emitted for each of the regions.

14. A method, comprising:
generating position information with a touch/pen (T/P) sensor surface;
emitting light through the T/P sensor surface; and
selectively blocking at least a portion of the emitted light to identify with the emitted light at least one border defining at least one region on the sensor surface.

15. The method of claim 14, wherein the at least one region comprises at least one of a mouse pad region for mouse device interactions, a pen region for pen interactions, and a touch region for touch interactions.
